(19) United States
(12) Patent Application Publication
(10) Pub. No.: US 2022/0252084 A1
(43) Pub. Date: Aug. 11, 2022

(54) CONSTRUCTION MACHINE AND CONTROL METHOD THEREFOR

(71) Applicant: HYUNDAI DOOSAN INFRACORE CO., LTD., Dong-gu Incheon (KR)

(72) Inventor: Byungil KANG, Yeonsu-gu, Incheon (KR)

(21) Appl. No.: 17/628,096

(22) PCT Filed: Jul. 6, 2020
(86) PCT No.: PCT/KR2020/008805

§ 371 Date: Jan. 18, 2022

(30) Foreign Application Priority Data
Jul. 17, 2019 (KR) 10-2019-0086271

(51) Int. Cl. F15B 1/04; E02F 3/32; E02F 3/42; E02F 9/22

(52) U.S. Cl. CPC F15B 1/04; E02F 3/32; E02F 9/2267; E02F 9/2217; E02F 9/2225; E02F 3/425

(57) ABSTRACT

A construction machine including a boom; an engine; a main pump discharging a working fluid; a working fluid tank storing the working fluid; a boom cylinder raising or lowering the boom and comprising a head side and a rod side; a regeneration line connected to the head side of the boom cylinder and moving the working fluid discharged from the head side of the boom cylinder; a regeneration motor operated by the working fluid moved through the regeneration line and assisting the engine; an accumulator connected to the regeneration line accumulating the working fluid discharged from the boom cylinder; a boom regeneration valve opening or closing the regeneration line; a main control valve controlling a supply of the working fluid, to the boom cylinder and discharge a part of the working fluid, which is discharged from the head side of the boom cylinder, to the working fluid tank.

### TECHNICAL FIELD

The present disclosure relates to a construction machine and a method of controlling the same, and more particularly, to a construction machine and a method of controlling the same, which improve fuel economy by restoring potential energy of a boom when the boom descends.

### BACKGROUND ART

Construction machines refer to all the machines used in civil engineering work or construction work. In general, the construction machine has an engine and a hydraulic pump that operates using power of the engine. The construction machine travels or operates working devices by power generated by the engine and the hydraulic pump.

For example, an excavator, which is one of the construction machines, refers to a construction machine that performs work such as excavation work for digging land, loading work for transporting soil, crushing work for dismantling buildings, and leveling work for leveling ground surfaces at civil engineering and construction sites. The excavator includes a traveling body configured to serve to move the excavator, an upper turning body mounted on the traveling body and configured to rotate by 360 degrees, and working devices.

In addition, the excavator includes drive devices such as a traveling motor used to move the excavator, a swing motor used to swing the upper turning body, and a boom cylinder, an arm cylinder, a bucket cylinder, and an option cylinder which are used for the working devices. Further, the drive devices are operated by a working fluid discharged from a variable capacity hydraulic pump operated by the engine or the electric motor.

In addition, recently, an energy regeneration system is applied to the construction machine. The energy regeneration system restores potential energy of the working device and uses the restored energy, as auxiliary energy, to operate the various types of drive devices.

In a case in which the working device such as a boom is moved upward or downward by the boom cylinder, the working fluid at a head side of the boom cylinder is pushed out at a high pressure from the boom cylinder by potential energy of the boom when the raised boom is lowered. The potential energy of the boom disappears as the high-pressure working fluid is converted into thermal energy and then dissipated or the high-pressure working fluid is returned to a storage tank.

Therefore, the energy regeneration system may accumulate the high-pressure working fluid in an accumulator and operate a regeneration motor with the accumulated working fluid, thereby reducing fuel consumption of the engine that operates the hydraulic pump.

However, a pressure of the working fluid discharged from the head side of the boom cylinder is changed by the accumulator, and the change in pressure makes it impossible for an operator to control a speed of the boom in accordance with the operator's manipulation intention. That is, because of the change in pressure in the accumulator, the energy regeneration system in the related art cannot cope with a change in descending speed of the boom that occurs regardless of the operator's manipulation intention.

Specifically, for example, the pressure is changed by the working fluid accumulated in the accumulator even though the operator constantly manipulates a joystick so that the boom descends at a constant speed when the operator lowers the boom by manipulating the joystick. As a result, a descending speed of the boom decreases contrary to the operator's manipulation intention. That is, as the boom descends, the pressure of the working fluid discharged from the boom cylinder increases, and resistance increases. For this reason, there is a problem in that the descending speed of the boom cannot be adjusted to a target speed and the boom is rapidly stopped.

### DISCLOSURE

### Technical Problem

The present disclosure has been made in an effort to provide a construction machine and a method of controlling the same, which restore potential energy of a boom during an operation of lowering the boom, thereby improving fuel economy, constantly controlling a speed of the boom in accordance with an operator's intention, and preventing the boom from being rapidly stopped.

### Technical Solution

An exemplary embodiment of the present disclosure provides a construction machine, which includes a boom, the construction machine including: an engine configured to generate power; a main pump configured to discharge a working fluid by being operated by the engine; a working fluid tank configured to store the working fluid to be discharged by the main pump; a boom cylinder configured to raise or lower the boom and including a head side and a rod side; a regeneration line connected to the head side of the boom cylinder and configured to move the working fluid discharged from the head side of the boom cylinder; a regeneration motor configured to be operated by the working fluid moved through the regeneration line and assist the engine; an accumulator connected to the regeneration line and configured to accumulate the working fluid discharged from the boom cylinder; a boom regeneration valve configured to open or close the regeneration line; and a main control valve configured to discharge a part of the working fluid, which is discharged from the head side of the boom cylinder, to the working fluid tank during an operation of lowering the boom.

The main control valve may discharge a part of the working fluid, which is discharged from the head side of the boom cylinder, to the working fluid tank when a speed of the boom decreases during the operation of lowering the boom.

The construction machine may further include a control device configured to control the main control valve to discharge a part of the working fluid, which is discharged from the head side of the boom cylinder, to the working fluid tank when a pressure in the accumulator or the regeneration line exceeds a preset reference pressure.

In addition, the construction machine may further include: an operating device; and a control device configured to control the main control valve to discharge a part of the working fluid, which is discharged from the head side of the boom cylinder, to the working fluid tank when a boom operating signal of the operating device is equal to or smaller than a preset reference signal value.

The construction machine may further include: a main hydraulic line configured to connect the main pump and the main control valve; a first boom hydraulic line configured to connect the main control valve and the head side of the boom cylinder; and a second boom hydraulic line configured to connect the main control valve and the rod side of the boom cylinder.

The construction machine may further include a circulation line branching off from the regeneration line and connected to the rod side of the boom cylinder or the second boom hydraulic line. Further, the boom regeneration valve may include: a first valve installed in the circulation line; and a second valve installed in the regeneration line.

The main control valve may include a boom control spool configured to control a supply of the working fluid, which is discharged from the main pump, to the boom cylinder. Further, the boom control spool may include: a first position at which the main hydraulic line and the first boom hydraulic line are connected and the second boom hydraulic line and the working fluid tank are connected; a second position at which the first boom hydraulic line and the second boom hydraulic line are blocked; and a third position at which the first boom hydraulic line and the working fluid tank are connected, the main hydraulic line and the second boom hydraulic line are connected, and the boom control spool is opened with a preset opening area relatively smaller than an opening area at the first position.

The boom control spool may be positioned at the second position during the operation of lowering the boom, and then the boom control spool may move to the third position when a pressure in the accumulator or the regeneration line exceeds a preset reference pressure.

In the state in which the boom control spool is positioned at the third position, the opening area of the boom control spool may increase in proportion to an increase in pressure in the accumulator or the regeneration line.

The boom regeneration valve may further include a holding valve installed in the regeneration line and configured to prevent the boom from being dropped by a weight thereof when the working fluid is not supplied to the boom cylinder.

The construction machine may further include: an energy storage line configured to connect the accumulator and the regeneration line; and an accumulator valve configured to open or close the energy storage line.

Still another exemplary embodiment of the present disclosure provides a method of controlling a construction machine, the method including: supplying a working fluid from a main pump to a boom cylinder to lower a boom of the construction machine; regenerating the working fluid discharged from the boom cylinder when the boom is lowered; detecting a stop operation of the boom when the boom is lowered; and discharging a part of the working fluid, which is discharged from the boom cylinder, to a working fluid tank when the stop operation is detected.

The stop operation of the boom may be detected by detecting a speed of the boom or detecting a boom operating signal of an operating device.

The stop operation of the boom may be detected by checking whether a pressure of the working fluid, which is discharged from the boom cylinder for regeneration, exceeds a preset reference pressure.

### Advantageous Effects

The construction machine and the method of controlling the same according to the embodiment of the present disclosure may restore the potential energy of the boom during the operation of lowering the boom, thereby improving fuel economy, constantly controlling the speed of the boom in accordance with the operator's intention, and preventing the boom from being rapidly stopped.

### DESCRIPTION OF DRAWINGS

FIG. 1 is a side view of a construction machine according to an embodiment of the present disclosure.

FIGS. 2 and 3 are hydraulic circuit diagrams of a hydraulic system used for the construction machine according to the embodiment of the present disclosure.

FIG. 4 is a graph illustrating a change in speed of a boom and a change in pressure in an accumulator in accordance with a change in pressure of a joystick.

FIG. 5 is a graph illustrating a change in speed of a boom in accordance with a change in signal pressure generated by a joystick according to a comparative example.

FIG. 6 is a graph illustrating a change in speed of a boom in accordance with a change in signal pressure generated by a joystick according to an experimental example.

### MODE FOR INVENTION

Hereinafter, embodiments of the present disclosure will be described in detail with reference to the accompanying drawings so that those with ordinary skill in the art to which the present disclosure pertains may easily carry out the embodiments. The present disclosure may be implemented in various different ways, and is not limited to the embodiments described herein.

It is noted that the drawings are schematic, and are not illustrated based on actual scales. Relative dimensions and proportions of parts illustrated in the drawings are exaggerated or reduced in size for the purpose of clarity and convenience in the drawings, and any dimension is just illustrative but not restrictive. The same reference numerals designate the same structures, elements or components illustrated in two or more drawings in order to exhibit similar characteristics.

Embodiments of the present disclosure illustrate ideal embodiments of the present disclosure in detail. As a result, various modifications of the drawings are expected. Therefore, the embodiments are not limited to specific forms in regions illustrated in the drawings, and for example, include modifications of forms by the manufacture thereof.

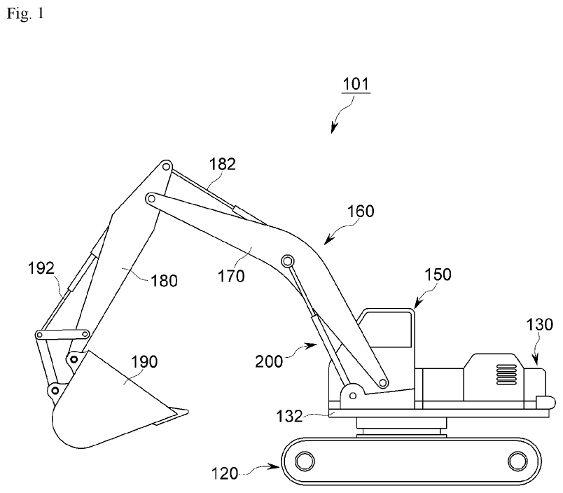

Hereinafter, a construction machine 101 according to an embodiment of the present disclosure will be described with reference to FIGS. 1 to 3. In the present specification, an excavator will be described as an example of the construction machine 101. However, the construction machine 101 is not limited to the excavator, and the present disclosure may be applied to all construction machines, each equipped with working devices 160 such as a boom 170 that generates potential energy.

As illustrated in FIG. 1, the construction machine 101 may include a lower traveling body 120, an upper turning body 130 turnably mounted on the lower traveling body 120, a cabin 150 installed on an upper turning body 130, and the working devices 160.

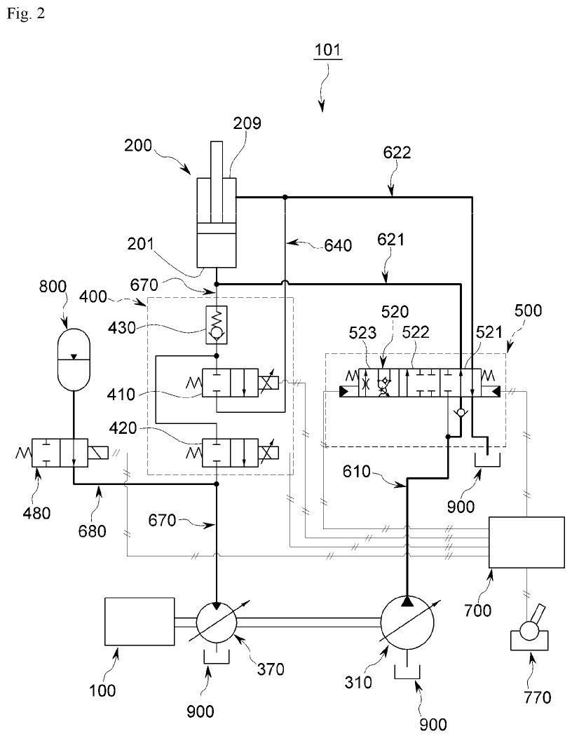

The lower traveling body 120 may support the upper turning body 130 and move the construction machine 101 by means of a traveling device using power generated by an engine 100 (illustrated in FIG. 2). The lower traveling body 120 may be an endless track type traveling body including an endless track or a wheel type traveling body including traveling wheels.

The upper turning body 130 may set a working direction by rotating on the lower traveling body 120. The upper turning body 130 may include an upper frame 132, and the cabin 150 and the working devices 160 installed on the upper frame 132.

The working devices 160 may include the boom 170, an arm 180, a bucket 190, and drive devices for operating the boom 170, the arm 180, and the bucket 190. For example, a boom cylinder 200 may be installed between the boom 170 and the upper frame 132 and control a motion of the boom 170. In addition, an arm cylinder 182 may be installed between the boom 170 and the arm 180 and control a motion of the arm 180.

A bucket cylinder 192 may be installed between the arm 180 and the bucket 190 and control a motion of the bucket 190.

As the boom cylinder 200, the arm cylinder 182, and the bucket cylinder 192 are extended or contracted, the boom 170, the arm 180, and the bucket 190 may implement various motions, and the working devices 160 may perform various types of work. In this case, the boom cylinder 200, the arm cylinder 182, and the bucket cylinder 192 are operated by a working fluid supplied from a main pump 310 (illustrated in FIG. 2) to be described below.

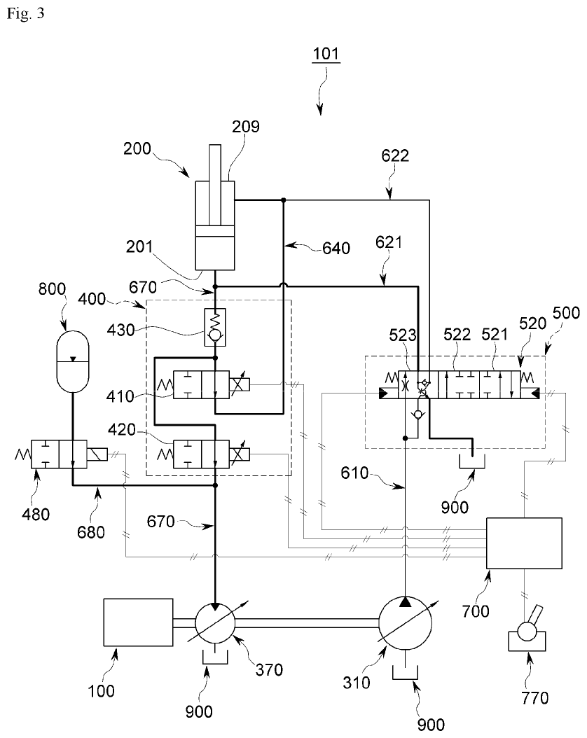

As illustrated in FIGS. 2 and 3, a hydraulic system used for the construction machine 101 according to the embodiment of the present disclosure includes the engine 100, the main pump 310, a working fluid tank 900, the boom cylinder 200, a regeneration line 670, a regeneration motor 370, an accumulator 800, a boom regeneration valve 400, and a main control valve (MCV) 500.

In addition, the hydraulic system used for the construction machine 101 according to the embodiment of the present disclosure may further include an operating device 770, a control device 700, a main hydraulic line 610, a first boom hydraulic line 621, a second boom hydraulic line 622, a circulation line 640, an energy storage line 680, and an accumulator valve 480.

The engine 100 generates power by combusting fuel. That is, the engine 100 supplies rotational power to the main pump 310 to be described below. In addition, the embodiment of the present disclosure is not limited thereto, and other power devices such as an electric motor may be used as the engine 100.

The main pump 310 discharges the working fluid by being operated by the power generated by the engine 100. The working fluid discharged from the main pump 310 may be supplied to the various types of drive devices including the boom cylinder 200 to be described below. In addition, the main pump 310 may be a variable capacity pump that adjusts a flow rate of the discharged working fluid by changing an angle of the swash plate. Hereinafter, in the present specification, the boom cylinder 200 will be described as an example of the several working devices 160.

The main control valve (MCV) 500 controls the supply of the working fluid, which is discharged from the main pump 310, to the various types of working devices 160 including the boom cylinder 200. Specifically, the main control valve 500 may include a plurality of control spools including a boom control spool 520. Further, the respective control spools control the supply of the working fluid to the various types of working devices including the boom cylinder 200. In addition, the main control valve 500 may further include spool caps (not illustrated) respectively connected to two opposite ends of the control spool and configured to stroke the control spool by receiving a pilot signal of the operating device to be described below. For example, an electronic proportional pressure reducing valve (EPPRV) may be installed on the spool cap. A pressure applied to the control spool by the pilot signal, which is transmitted by the pressure of the working fluid, varies depending on a degree to which the EPPRV is opened, and the control spool is moved in two directions by the pressure applied by the pilot signal.

The boom control spool 520 controls the supply of the working fluid, which is discharged from the main pump 310, to the boom cylinder 200. Specifically, the boom control spool 520 may differently control whether to supply the working fluid and the movement directions depending on a first position 521, a second position 522, and a third position 523. In addition, the boom control spool 520 may form a variable orifice having an opening area that varies depending on the positions.

At the first position 521 of the boom control spool 520, the main hydraulic line 610 may be connected to the first boom hydraulic line 621 to be described below, and the second boom hydraulic line 622 to be described below may be connected to the working fluid tank 900 to be described below.

At the second position 522 of the boom control spool 520, the first boom hydraulic line 621 and the second boom hydraulic line 622 may be blocked. At the third position 523 of the boom control spool 520, the first boom hydraulic line 621 may be connected to the working fluid tank 900, and the main hydraulic line 610 may be connected to the second boom hydraulic line 622.

The operating device 770 may include a joystick, an operating lever, a pedal, and the like installed in the cabin so that an operator may manipulate the various types of working devices 160 and the traveling device. The operating device 770 is manipulated by the operator. The control device 500 to be described below may control the boom regeneration valve 400 and the main control valve 500 on the basis of a signal from the operating device 770. Therefore, the main control valve 500 may adjust the working fluid to be supplied to the various types of working devices 160. For example, the operating device 770 may include the joystick for raising or lowering the boom 170.

The main hydraulic line 610 connects the main pump 310 and the main control valve 500. That is, the main hydraulic line 610 transfers the working fluid, which is discharged from the main pump 310, to the main control valve 500 so that the main control valve 500 may adjust and distribute the working fluid to the various types of working devices 160 and the traveling device.

The working fluid tank 900 restores the working fluid, which has been discharged from the main pump 310 and then used, and stores the working fluid so that the main pump 310 may discharge the working fluid again.

The boom cylinder 200 raises or lowers the boom 170. Further, the boom cylinder 200 includes a head side 201 and a rod side 209.

The first boom hydraulic line 621 connects the main control valve 500 and the head side 201 of the boom cylinder 200, and the second boom hydraulic line 622 connects the main control valve 500 and the rod side 209 of the boom cylinder 200. Specifically, the first boom hydraulic line 621 is connected to the head side 201 of the boom cylinder 200 and supplies the working fluid to the boom cylinder 200 during the operation of raising the boom 170. Further, the second boom hydraulic line 622 is connected to the rod side 209 of the boom cylinder 200 and supplies the working fluid to the boom cylinder 200 to lower the boom 170.

The regeneration line 670 is connected to the head side 201 of the boom cylinder 200 and moves the working fluid discharged from the head side 201 of the boom cylinder 200. For example, the regeneration line 670 branches off from the first boom hydraulic line 621 and moves the working fluid, which is discharged from the head side 201 of the boom cylinder 200, during the operation of lowering the boom 170. Further, the regeneration line 670 is connected to the regeneration motor 370 to be described below. That is, the working fluid, which is discharged from the boom cylinder 200 and moves along the regeneration line 670, operates the regeneration motor 370.

The circulation line 640 branches off from the regeneration line 670 and is connected to the second boom hydraulic line 622 or the rod side 209 of the boom cylinder 200. Therefore, a part of the working fluid, which is discharged from the head side 201 of the boom cylinder 200 during the operation of lowering the boom 170, is introduced into the rod side 209 of the boom cylinder 200 through the circulation line 640. As described above, when the high pressure at the head side 201 of the boom cylinder 200 is transmitted to the rod side 209 of the boom cylinder 200 during the operation of lowering the boom 170, the pressure at the rod side 209 increases, the increased pressure at the rod side 209 increases the pressure at the head side 201 again, which makes it possible to improve efficiency in using energy.

The boom regeneration valve 400 opens or closes the regeneration line 670. Specifically, the boom regeneration valve 400 may include: a first valve 410 configured to control a flow rate of the working fluid flowing from the head side 201 of the boom cylinder 200 to the rod side 209 of the boom cylinder 200 through the circulation line 640; and a second valve 420 configured to control a flow rate of the working fluid to be supplied from the head side 201 of the boom cylinder 200 to the regeneration motor 370 or the accumulator 800 through the regeneration line 670. For example, the control device 700 to be described below may move the first and second valves 410 and 420 to the opened positions during the operation of lowering the boom 170 and move the first and second valves 410 and 420 to the closed positions during the operation of raising the boom 170. Meanwhile, the first valve 410 and the second valve 420 are respectively installed in the circulation line 640 and the regeneration line 670 and not only open or close the circulation line 640 and the regeneration line 670 but also adjust the flow rate of the working fluid passing through the circulation line 640 and the regeneration line 670.

In addition, the boom regeneration valve 400 may further include a holding valve 430 installed in the regeneration line 670 and configured to prevent the boom 170 from being dropped by a weight thereof when the working fluid is not supplied to the boom cylinder 200.

The regeneration motor 370 is connected to the regeneration line 670 and operated by the pressure of the working fluid supplied through the regeneration line 670. The regeneration motor 370 may assist the engine 100 in operating the main pump 310. That is, the fuel consumption of the engine 100 may be reduced as much as the regeneration motor 370 operates the main pump 310. In addition, the regeneration motor 370 may also be a variable capacity motor and adjust an angle of a swash plate on the basis of a signal from the control device 700. For example, the engine 100, the main pump 310, and the regeneration motor 370 may be directly connected.

The accumulator 800 is connected to the regeneration line 670 and accumulates the working fluid discharged from the boom cylinder 200. The accumulator 800 refers to a device that stores the high-pressure working fluid in the hydraulic system.

The energy storage line 680 connects the accumulator 800 and the regeneration line 670, and the accumulator valve 480 is installed in the energy storage line 680 and opens or closes the energy storage line 680.

The accumulator valve 480 is controlled by the control device 700 to be described below. The accumulator valve 480 is opened during the operation of lowering the boom 170 and when the regeneration motor 370 is opened by the high-pressure working fluid stored in the accumulator 800.

The control device 700 may control several devices of the construction machine 101, such as the engine 100, the main pump 310, the regeneration motor 370, and the main control valve 500. Further, the control device 700 may include one or more of an engine control unit (ECU) and a vehicle control unit (VCU).

In addition, in the embodiment of the present disclosure, the control device 700 controls the boom regeneration valve 400 and the main control valve 500 on the basis of the signal from the operating device 770. For example, the operating device 770 may be a joystick, and a signal of the operating device 770 may be a pilot pressure generated by the manipulation of the joystick.

Specifically, the control device 700 may control the supply of the working fluid, which is discharged from the main pump 310, to the boom cylinder 200 by controlling the boom control spool 520 of the main control valve 500 on the basis of the signal of the operating device 770. That is, the control device 700 may control the boom control spool 520 of the main control valve 500 so that the working fluid, which is discharged from the main pump 310, is supplied to the head side 201 of the boom cylinder 200 during the operation of raising the boom 170. In this case, as illustrated in FIG. 1, the boom control spool 520 may be positioned at the first position 521.

In addition, the control device 700 may control the boom control spool 520 of the main control valve 500 to block the inflow or outflow of the working fluid to/from the boom cylinder 200 when the boom 170 is stopped. In this case, the boom control spool 520 may be positioned at the second position 522.

In addition, the control device 700 controls the boom control spool 520 of the main control valve 500 so that a part of the working fluid discharged from the head side 201 of the boom cylinder 200 is discharged to the working fluid tank 900 when a boom operating signal of the operating device 770 is equal to or smaller than a preset reference signal value or a pressure in the accumulator 800 or the regeneration line 670 exceeds a preset reference pressure during the operation of lowering the boom 170. In this case, the preset reference signal value may be a reference pilot pressure generated by the manipulation of the operating device 770. That is, during the operation of lowering the boom 170, the boom control spool 520 is positioned at the second position 522, and then the boom control spool moves to the third position, as illustrated in FIG. 2, when the boom operating signal of the operating device 770 is equal to or smaller than the preset reference signal value or the pressure in the accumulator 800 or the regeneration line 670 exceeds the preset reference pressure. In this case, the preset reference pressure may be variously set depending on the performance of the accumulator 800, the boom cylinder 200, and the main pump 310. In addition, the pressure in the accumulator 800 or the regeneration line 670 may be measured by a pressure sensor (not illustrated). The method of measuring the pressure in the accumulator 800 or the regeneration line 670 by using the pressure sensor is well known to those skilled in the art.

As described above, in the embodiment of the present disclosure, when the boom operating signal of the operating device 770 is equal to or smaller than the preset reference signal value or the pressure in the accumulator 800 or the regeneration line 670 exceeds the preset reference pressure, the boom control spool 520 of the main control valve 500 is opened to a preset opening area, such that a part of the working fluid discharged from the head side 201 of the boom cylinder 200 is discharged to the working fluid tank 900. Therefore, it is possible to prevent a decrease in descending speed of the boom 170 or a rapid stop of the boom 170 even though the pressure in the accumulator 800 increases.

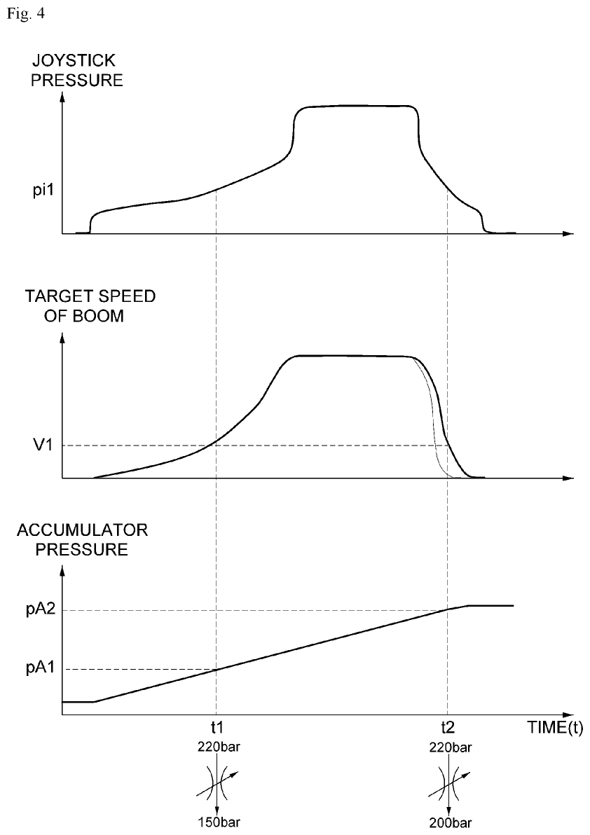

In addition, it is possible to simplify the entire configuration of the construction machine 101 by preventing the rapid stop of the boom 170 by using the main control valve 500 without using a separate device for inhibiting or offsetting the increase in pressure in the accumulator 800 and the regeneration line 670. If the boom control spool 520 does not move from the second position 522 to the third position 523 even when the boom operating signal of the operating device 770 is equal to or smaller than the preset reference signal value or the pressure in the accumulator 800 or the regeneration line 670 exceeds the preset reference pressure, the pressure in the accumulator 800 increases as the boom 170 is lowered and the working fluid begins to be accumulated in the accumulator 800, and the pressure in the regeneration line 670 also increases in proportion to the increase in pressure in the accumulator 800, as illustrated in FIG. 4. For this reason, the flow rate of the working fluid discharged through the regeneration line 670 decreases, and the descending speed of the boom 170 decreases when the pressure in the accumulator 800 becomes a predetermined pressure or higher.

When comparing a point in time t1 and a point in time t2 in FIG. 3, a pilot pressure pi1 generated by the joystick, which is the operating device 770, is constant, and a target speed of the boom according to the pilot pressure pi1 is also constant. In this case, the target speed may be a movement speed of the boom 170 which is moved by the operating device 770 in accordance with the operator's intention. However, the pressure in the accumulator 800, which is pA1 at the point in time t2, increases to pA2 at the point in time t2, which means that resistance against the discharge of the working fluid from the boom cylinder 200 is increased. That is, if a difference between the pressure at the head side 201 of the boom cylinder 200 and the pressure in the regeneration line 670 is 70 bar at the point in time t1, the difference between the pressure at the head side 201 of the boom cylinder 200 and the pressure in the regeneration line 670 decreases to 20 bar at the point in time t2. Therefore, during the operation of lowering the boom 170, the speed of the boom 170 is not controlled as indicated by the thick solid line indicating the target speed, but the boom is rapidly stopped as indicated by a thin solid line. The rapid decrease in speed of the boom causes discomfort to the operator who controls the operation of the boom 170 through the operating device 770 or makes it difficult to perform the precise control.

In addition, as the pressure in the accumulator 800 increases, the preset opening area of the boom control spool 520, which is opened at the third position 523, may increase. That is, when the pressure in the accumulator 800 or the regeneration line 670 exceeds the preset reference pressure during the operation of lowering the boom 170, the boom control spool 520 moves to the third position 523 and discharges a part of the working fluid, which is discharged from the head side 201 of the boom cylinder 200, to the working fluid tank 900. In this case, the opening area at the third position 523 of the boom control spool 520 may be 0.6 times the opening area at the first position 521.

Thereafter, when the pressure in the accumulator 800 gradually increases, the opening area at the third position 523 of the boom control spool 520 may increase to 0.9 times the opening area at the first position 521. That is, in proportion to the increase in pressure in the accumulator 800, the boom control spool 520 of the main control valve 500 may increase the flow rate of the working fluid discharged to the working fluid tank 900 from the head side 201 of the boom cylinder 200.

Therefore, it is possible to effectively prevent the pressure in the accumulator 800 from excessively increasing, thereby preventing the excessive increase in pressure in the accumulator 800 from affecting the descending speed of the boom 170. That is, it is possible to operate the boom 170 in accordance with the operator's manipulation intention by preventing the rapid decrease in descending speed of the boom 170.

With the above-mentioned configuration, the construction machine 101 according to the embodiment of the present disclosure may restore the potential energy of the boom 170 during the operation of lowering the boom 170, thereby improving fuel economy, constantly controlling the speed of the boom 170 in accordance with the operator's intention, and preventing the boom 170 from being rapidly stopped.

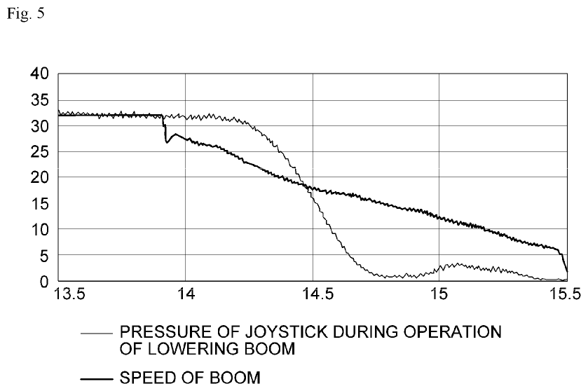

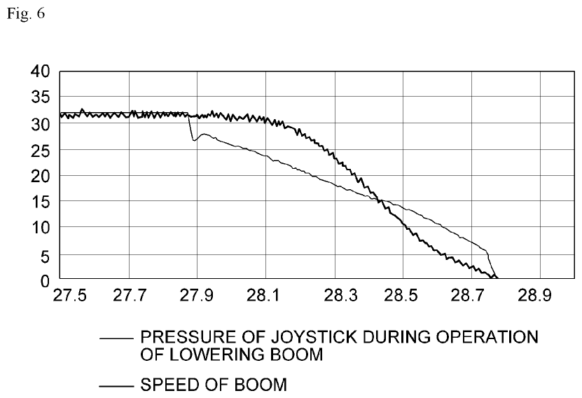

Hereinafter, a comparison between an experimental example according to the embodiment of the present disclosure and a comparative example will be described with reference to FIGS. 4 and 5.

FIG. 4 is a graph illustrating a speed of the boom and a change in pilot pressure generated by the manipulation of the joystick when the joystick, which is the operating device 770, is manipulated to lower the boom in a comparative example in which the main control valve 500 does not discharge a part of the working fluid, which is discharged from the head side 201 of the boom cylinder 200, to the working fluid tank 900 during the operation of lowering the boom 170.

It can be seen from FIG. 4 that the speed of the boom 170 rapidly decreases in a particular section even though the pilot pressure indicating the operator's manipulation intention changes with a constant gradient.

In contrast, FIG. 5 is a graph illustrating a speed of the boom and a change in pilot pressure generated by the manipulation of the joystick when the joystick, which is the operating device 770, is manipulated to lower the boom in an experimental example in which the main control valve 500 discharges a part of the working fluid, which is discharged from the head side 201 of the boom cylinder 200, to the working fluid tank 900 during the operation of lowering the boom 170 according to the embodiment of the present disclosure.

It can be seen from FIG. 5 that as the pilot pressure indicating the operator's manipulation intention changes with a constant gradient, the speed of the boom 170 also decreases with a constant gradient.

Hereinafter, a method of controlling the construction machine 101 according to the embodiment of the present disclosure will be described.

The construction machine 101 has, but not necessarily limited to, a structure identical to the above-mentioned structure.

The method of controlling the construction machine 101 may include: supplying the working fluid from the main pump 310 to the boom cylinder 200 to lower the boom 170; regenerating the working fluid discharged from the boom cylinder 200 when the boom 170 is lowered; detecting a stop operation of the boom 170 when the boom 170 is lowered; and discharging a part of the working fluid, which is discharged from the boom cylinder 170, to the working fluid tank 900 when the stop operation of the boom 170 is detected.

Specifically, in the regenerating of the working fluid, the working fluid discharged from the boom cylinder 200 is stored in the accumulator 800 or the regeneration motor 370 is operated by the working fluid discharged from the boom cylinder 200.

In addition, in the detecting of the stop operation of the boom 170 when the boom 170 is lowered, the speed of the boom 170 may be detected or the stop operation of the boom 170 may be detected by detecting the boom operating signal of the operating device 770.

In addition, in the detecting of the stop operation of the boom 170 when the boom 170 is lowered, the stop operation of the boom 170 may be detected by checking whether the pressure of the working fluid, which is discharged from the boom cylinder 200 for the regeneration, exceeds a preset reference pressure.

While the embodiments of the present disclosure have been described with reference to the accompanying drawings, those skilled in the art will understand that the present disclosure may be carried out in any other specific form without changing the technical spirit or an essential feature thereof.

Accordingly, it should be understood that the aforementioned embodiments are described for illustration in all aspects and are not limited, and the scope of the present disclosure shall be represented by the claims to be described below, and it should be construed that all of the changes or modified forms induced from the meaning and the scope of the claims, and an equivalent concept thereto are included in the scope of the present disclosure.

### INDUSTRIAL APPLICABILITY

The construction machine and the method of controlling the same according to the embodiment of the present disclosure may be used to restore the potential energy of the boom during the operation of lowering the boom, thereby improving the fuel economy, constantly controlling the speed of the boom in accordance with the operator's intention, and preventing the boom from being rapidly stopped.

1. A construction machine, which comprises a boom, the construction machine comprising:
an engine configured to generate power;
a main pump configured to discharge a working fluid by being operated by the engine;
a working fluid tank configured to store the working fluid to be discharged by the main pump;
a boom cylinder configured to raise or lower the boom and comprising a head side and a rod side;
a regeneration line connected to the head side of the boom cylinder and configured to move the working fluid discharged from the head side of the boom cylinder;
a regeneration motor configured to be operated by the working fluid moved through the regeneration line and assist the engine;
an accumulator connected to the regeneration line and configured to accumulate the working fluid discharged from the boom cylinder;
a boom regeneration valve configured to open or close the regeneration line; and
a main control valve configured to discharge a part of the working fluid, which is discharged from the head side of the boom cylinder, to the working fluid tank during an operation of lowering the boom.

2. The construction machine of claim 1, wherein the main control valve discharges a part of the working fluid, which is discharged from the head side of the boom cylinder, to the working fluid tank when a speed of the boom decreases during the operation of lowering the boom.

3. The construction machine of claim 1, further comprising:
a control device configured to control the main control valve to discharge a part of the working fluid, which is discharged from the head side of the boom cylinder, to the working fluid tank when a pressure in the accumulator or the regeneration line exceeds a preset reference pressure.

4. The construction machine of claim 1, further comprising:
an operating device; and
a control device configured to control the main control valve to discharge a part of the working fluid, which is discharged from the head side of the boom cylinder, to the working fluid tank when a boom operating signal of the operating device is equal to or smaller than a preset reference signal value.

5. The construction machine of claim 1, further comprising:
a main hydraulic line configured to connect the main pump and the main control valve;
a first boom hydraulic line configured to connect the main control valve and the head side of the boom cylinder; and
a second boom hydraulic line configured to connect the main control valve and the rod side of the boom cylinder.

6. The construction machine of claim 5, further comprising:
a circulation line branching off from the regeneration line and connected to the rod side of the boom cylinder or the second boom hydraulic line,
wherein the boom regeneration valve comprises:
a first valve installed in the circulation line; and
a second valve installed in the regeneration line.

7. The construction machine of claim 1, wherein the main control valve comprises a boom control spool configured to control a supply of the working fluid, which is discharged from the main pump, to the boom cylinder, and
wherein the boom control spool comprises:
a first position at which the main hydraulic line and the first boom hydraulic line are connected and the second boom hydraulic line and the working fluid tank are connected;
a second position at which the first boom hydraulic line and the second boom hydraulic line are blocked; and
a third position at which the first boom hydraulic line and the working fluid tank are connected, the main hydraulic line and the second boom hydraulic line are connected, and the boom control spool is opened with a preset opening area relatively smaller than an opening area at the first position.

8. The construction machine of claim 7, wherein the boom control spool is positioned at the second position during the operation of lowering the boom, and then the boom control spool moves to the third position when a pressure in the accumulator or the regeneration line exceeds a preset reference pressure.

9. The construction machine of claim 8, wherein in the state in which the boom control spool is positioned at the third position, the opening area of the boom control spool increases in proportion to an increase in pressure in the accumulator or the regeneration line.

10. The construction machine of claim 1, wherein the boom regeneration valve further comprises a holding valve installed in the regeneration line and configured to prevent the boom from being dropped by a weight thereof when the working fluid is not supplied to the boom cylinder.

11. The construction machine of claim 1, further comprising:
an energy storage line configured to connect the accumulator and the regeneration line; and
an accumulator valve configured to open or close the energy storage line.

12. A construction machine, which comprises a boom, the construction machine comprising:
an engine configured to generate power;
a main pump configured to discharge a working fluid by being operated by the engine;
a working fluid tank configured to store the working fluid to be discharged by the main pump;
a boom cylinder configured to raise or lower the boom and comprising a head side and a rod side;
a regeneration line connected to the head side of the boom cylinder and configured to move the working fluid discharged from the head side of the boom cylinder;
a regeneration motor configured to be operated by the working fluid moved through the regeneration line and assist the engine;
an accumulator connected to the regeneration line and configured to accumulate the working fluid discharged from the boom cylinder;
a boom regeneration valve configured to open or close the regeneration line;
a main control valve configured to control a supply of the working fluid, which is discharged from the main pump, to the boom cylinder;
an operating device; and
a control device configured to control the main control valve on the basis of a boom operating signal of the operating device,
wherein the control device controls the main control valve to discharge a part of the working fluid, which is discharged from the head side of the boom cylinder, to the working fluid tank when the boom operating signal of the operating device is equal to or smaller than a preset reference signal value, and
wherein the control device controls the main control valve so as to discharge a part of the working fluid, which is discharged from the head side of the boom cylinder, to the working fluid tank when a pressure in the accumulator or the regeneration line exceeds a preset reference pressure.

13. A method of controlling a construction machine, the method comprising:
supplying a working fluid from a main pump to a boom cylinder to lower a boom of the construction machine;
regenerating the working fluid discharged from the boom cylinder when the boom is lowered;
detecting a stop operation of the boom when the boom is lowered; and
discharging a part of the working fluid, which is discharged from the boom cylinder, to a working fluid tank when the stop operation is detected.

14. The method of claim 13, wherein the stop operation of the boom is detected by detecting a speed of the boom or detecting a boom operating signal of an operating device.

15. The method of claim 13, wherein the stop operation of the boom is detected by checking whether a pressure of the working fluid, which is discharged from the boom cylinder for regeneration, exceeds a preset reference pressure.
